(19) United States
(12) Patent Application Publication
(10) Pub. No.: US 2026/0250445 A1
(43) Pub. Date: Aug. 27, 2026

(54) AQUEOUS DRILLING FLUID FOR REDUCING BITUMEN ACCRETION

(71) Applicant: SECURE SPECIALITY CHEMICALS CORP., Calgary (CA)

(72) Inventors: Kuangbiao MA, Calgary (CA); Stuart DUBBERLEY, Calgary (CA)

(21) Appl. No.: 19/651,259

(22) Filed: Apr. 17, 2026

Related U.S. Application Data
(63) Continuation of application No. 16/210,268, filed on Dec. 5, 2018.
(60) Provisional application No. 62/594,760, filed on Dec. 5, 2017.

(51) Int. Cl. C08F 220/56; C08F 220/06; C08F 220/10; C08F 220/34; C09K 8/04; C09K 8/12; C09K 8/524; E21B 21/06; E21B 37/06

(52) U.S. Cl. CPC C08F 220/56; C09K 8/04; C09K 8/12; C09K 8/524; E21B 37/06; C08F 2800/20; E21B 21/062; E21B 21/065

(57) ABSTRACT

Some embodiments of the present disclosure relate to drilling fluids that comprise an aqueous solvent and an ampholytic semi-hydrophobic polymer that is readily hydratable under field mixing conditions. The ampholytic semi-hydrophobic polymer comprises semi-hydrophobic monomer units comprising a C₁-C₇ hydrocarbyl substituent, a hydrogen substituent, or a combination thereof. Some embodiments of the present disclosure relate to use of a drilling fluid as defined herein to reduce bitumen accretion to a wellbore drilling component. Some embodiments of the present disclosure relate to methods for reducing bitumen accretion to a wellbore drilling component, the method comprising introducing a drilling fluid as defined herein into a wellbore containing the wellbore drilling component.

### CROSS-REFERENCE TO RELATED APPLICATION

This application is a continuation of U.S. patent application Ser. No. 16/210,268, filed Dec. 5, 2018, which claims the benefit of U.S. Provisional Application No. 62/594,760 filed Dec. 5, 2017, the contents of which are incorporated herein by reference.

### TECHNICAL FIELD

The present disclosure generally relates to drilling fluids. In particular, the present disclosure relates to aqueous drilling fluids with polymer-based anti-accretion agents.

### BACKGROUND

Drilling fluids are relied on to perform numerous functions during wellbore drilling. For example, drilling fluids are used to reduce friction associated with drill bit advancement, to reduce corrosion of wellbore drilling components, and to minimize hydrostatic pressure differentials within the wellbore. Drilling fluids also aid in transporting drill cuttings within the wellbore and away from a drill bit and towards a collection point where they can be removed by mechanical or physical means.

The potential for drilling fluids to aid in the transportation of drill cuttings away from the drill bit is particularly important when drilling within bitumen-containing reservoirs. Bitumen has a high viscosity and tends to accrete (i.e. stick) to wellbore drilling components and peripheral equipment. For example, bitumen often accretes to drill strings, bottom-hole assemblies, and solids-control equipment. In some instances, bitumen accretion forces operators to delay drilling operations while bitumen-caked components are cleaned or replaced.

Bitumen accretion equilibria are largely dictated by hydrophobicity and electrostatic charge interactions. Bitumen is largely composed of hydrophobic, aliphatic and aromatic compounds, and bitumen tends to form surfaces with dispersed charges. Unfortunately, conventional aqueous-based drilling fluids are not well suited to reducing bitumen accretion due (at least in part) to their poorly matched hydrophobicity and electrostatic charge profiles. Thus, anti-accretion agents, which are intended to influence accretion equilibria, are often included in aqueous drilling fluids for use in drilling bitumen containing reservoirs.

### SUMMARY

Aqueous drilling fluids that include anti-accretion agents in the form of water-soluble polymers having hydrophobic functional groups are known. Aqueous drilling fluids that include polymers with backbones containing both positive and negative formal charges (i.e. ampholytic polymers) are also known. Anti-accretion agents having both of these characteristics, i.e. ampholytic hydrophobic polymer-based anti-accretive agents, have also been proposed as components of aqueous drilling fluids for use in bitumen-containing reservoirs. However, the ampholytic hydrophobic polymer-based anti-accretive agents disclosed to date are constrained by, among other things, their slow hydration rates under field mixing conditions. For example, the ampholytic hydrophobic polymers disclosed to date require high sheer rate mixing to provide adequate polymer hydration rates. High sheer rate mixing is often not practical in the field as it requires specialized equipment. As a result, the ampholytic hydrophobic polymers disclosed to date often require an off-site pre-hydration step. Off-site pre-hydration steps can add undue complexity to shipping and storage arrangements, and they are often time/cost intensive. Accordingly, there exists a need for drilling fluids having ampholytic polymers with alternate solubility characteristics.

Aspects of the present disclosure relate to a drilling fluid comprising: an aqueous solvent; and an ampholytic semi-hydrophobic polymer that is hydratable under field mixing conditions, wherein the ampholytic semi-hydrophobic polymer comprises semi-hydrophobic monomer units comprising a C₁-C₇ hydrocarbyl substituent, a hydrogen substituent, or a combination thereof.

Some embodiments of the present disclosure relate to drilling fluids wherein the semi-hydrophobic monomer units are present in the ampholytic hydrophobic polymer in an amount of less than 10% (w/w).

Some embodiments of the present disclosure relate to drilling fluids that are readily hydratable under field mixing conditions in that the ampholytic semi-hydrophobic polymer obtains greater than about 35% of the ultimate apparent viscosity thereof when mixed for about 10 minutes: in an approximately cylindrical container having a volume of 600 mL; at a speed of about 250 rpm with an approximately octagonal stir bar having a first dimension of about 0.7 cm and a second dimension of about 6 cm; at a concentration of about 5 kg/m³ in an aqueous solution having a volume of about 300 mL, a total dissolved solids measure of less than about 100 mg/L, and a pH of about 7; at a temperature within a range of about 20° C. to about 25° C.; and at a pressure of about 1 atm.

Some embodiments of the present disclosure relate to drilling fluids wherein the C₁-C₇ hydrocarbyl substituent is a C₁-C₇ alkyl substituent, a C₂-C₇ alkenyl substituent, a C₂-C₇ alkynyl substituent, or a combination thereof.

Some embodiments of the present disclosure relate to drilling fluids wherein the C₁-C₇ hydrocarbyl substituent is a C₄-C₇ alkyl substituent, a C₄-C₇ alkenyl substituent, a C₄-C₇ alkynyl substituent, or a combination thereof.

Some embodiments of the present disclosure relate to drilling fluids wherein the semi-hydrophobic monomer units are cationic semi-hydrophobic monomer units.

Some embodiments of the present disclosure relate to drilling fluids wherein the cationic semi-hydrophobic monomer units comprise a quaternary ammonium substituent.

Some embodiments of the present disclosure relate to drilling fluids wherein the cationic semi-hydrophobic monomer units are as shown in formula (I) or formula (II):

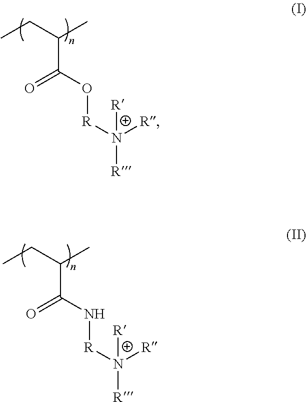

wherein n is an integer between 1 and about 300,000, and wherein R, R′, R″, and R′″ are each independently a C₁-C₇ alkyl substituent, a C₂-C₇ alkenyl substituent, a C₂-C₇ alkynyl substituent, or a hydrogen substituent.

Some embodiments of the present disclosure relate to drilling fluids wherein the cationic semi-hydrophobic monomer units are as shown in formula (I) or formula (II) wherein n is an integer between 1 and about 300,000, and wherein R, R′, R″, and R′″ are each independently a C₄-C₇ alkyl substituent, a C₄-C₇ alkenyl substituent, or a C₄-C₇ alkynyl substituent.

Some embodiments of the present disclosure relate to drilling fluids wherein the ampholytic semi-hydrophobic polymer further comprises anionic monomer units and non-ionic monomer units.

Some embodiments of the present disclosure relate to drilling fluids wherein the anionic monomer units comprise monomer units having a carboxylate substituent or a sulfonate substituent.

Some embodiments of the present disclosure relate to drilling fluids wherein the anionic monomer units are acrylate monomer units.

Some embodiments of the present disclosure relate to drilling fluids wherein the non-ionic monomer units comprise monomer units having an amide substituent.

Some embodiments of the present disclosure relate to drilling fluids wherein the non-ionic monomer units are acrylamide monomer units.

Some embodiments of the present disclosure relate to drilling fluids wherein between about 0.1% and 10% (w/w) of the ampholytic semi-hydrophobic polymer is comprised of the cationic semi-hydrophobic monomer units.

Some embodiments of the present disclosure relate to drilling fluids wherein between about 2% and about 4% (w/w) of the ampholytic semi-hydrophobic polymer is comprised of the cationic semi-hydrophobic monomer units.

Some embodiments of the present disclosure relate to drilling fluids wherein between about 10% and about 20% (w/w) of the ampholytic semi-hydrophobic polymer is comprised of the anionic monomer units.

Some embodiments of the present disclosure relate to drilling fluids wherein between about 75% and about 95% (w/w) of the ampholytic semi-hydrophobic polymer is comprised of the non-ionic monomer units.

Some embodiments of the present disclosure relate to drilling fluids wherein the semi-hydrophobic monomer units are anionic semi-hydrophobic monomer units.

Some embodiments of the present disclosure relate to drilling fluids wherein the semi-hydrophobic monomer units are non-ionic semi-hydrophobic monomer units.

Some embodiments of the present disclosure relate to drilling fluids wherein the ampholytic semi-hydrophobic polymer has a molecular weight within a range of about 5,000 to about 30,000,000 Daltons.

Some embodiments of the present disclosure relate to drilling fluids which further comprise an additive.

Some embodiments of the present disclosure relate to drilling fluids wherein the additive is a viscosifier, a weighting compound, a corrosion inhibitor, a lost circulation material, a fluid-loss control material, a lubricant, a flocculant, a thinner, a deflocculant, a dispersant, a surfactant, a biocide, a pH control material, a scale inhibitor, a shale stabilizer, an iron controller, a defoamer, or a combination thereof.

Some embodiments of the present disclosure relate to drilling fluids wherein the viscosifier is xanthan gum, diutan gum, sodium montmorillonite, or a combination thereof.

Some embodiments of the present disclosure relate to drilling fluids wherein the fluid-loss control material is polyanionic cellulose, a modified starch, a non-modified starch, or a combination thereof.

Aspects of the present disclosure relate to use of a drilling fluid as defined herein to reduce bitumen accretion to a wellbore drilling component.

Aspects of the present disclosure relate to a method for reducing bitumen accretion on a wellbore drilling component, the method comprising introducing a drilling fluid into a wellbore containing the wellbore drilling component, wherein the drilling fluid comprises: an aqueous solvent; and an ampholytic semi-hydrophobic polymer that is hydratable under field mixing conditions, wherein the ampholytic semi-hydrophobic polymer comprises semi-hydrophobic monomer units comprising a C₁-C₇ hydrocarbyl substituent, a hydrogen substituent, or a combination thereof.

Aspects of the present disclosure relate to a method for reducing bitumen accretion on a wellbore drilling component, the method comprising introducing a drilling fluid as defined herein into a reservoir containing the wellbore drilling component.

Some embodiments of the present disclosure relate to methods for reducing bitumen accretion on a wellbore drilling component wherein the drilling fluid is circulated through the wellbore.

Some embodiments of the present disclosure relate to methods for reducing bitumen accretion on a wellbore drilling component further comprising separating drill cuttings from the drilling fluid.

### DETAILED DESCRIPTION

Known anti-accretion agents based on ampholytic hydrophobic polymers are limited by their slow hydration rates under field mixing conditions. In the present disclosure, it is shown that ampholytic polymers having monomer units with attenuated hydrophobicity are suitable alternatives. Embodiments of the present disclosure relate to drilling fluids that comprise ampholytic polymers that are based on such semi-hydrophobic monomer units and that are readily hydratable under field mixing conditions. At the same time, ampholytic polymers based on semi-hydrophobic monomer units, are suitable for reducing bitumen accretion in systems using aqueous drilling fluids, while the drilling fluids can still perform the other functions of reducing drill bit friction, reducing corrosion, minimizing hydrostatic pressure differentials within the wellbore and transporting drill cuttings away from the drill bit.

Without being bound to any particular theory, it is proposed that the ampholytic semi-hydrophobic polymers in the drilling fluids of the present disclosure are readily hydratable under field mixing conditions because the hydrophobicity of their monomeric units is attenuated. In particular, the monomeric units comprising a C₁-C₇ hydrocarbyl substituent, a hydrogen substituent, or a combination thereof, may be less hydrophobic than monomeric units comprising a C₈₊ hydrocarbyl substituent. For ampholytic semi-hydrophobic polymers, the hydrophilic nature of other polymer functionalities (e.g. heteroatoms, cationic charges, anionic charges, or combinations thereof) is sufficient to provide a polymer which is readily hydratable under field mixing conditions, because the hydrophobicity of the monomeric units is attenuated.

Without being bound to any particular theory, it is further proposed that the ampholytic semi-hydrophobic polymers in the drilling fluids of the present disclosure reduce bitumen accretion by coating or encapsulating bitumen-containing drill cuttings and exposed walls of the wellbore. The coating or encapsulation may be driven by surface tension and/or hydrophobic effects between surfaces of the bitumen-containing cuttings and the semi-hydrophobic substituents of the semi-hydrophobic monomer units. The coating or encapsulation may also be driven by electrostatic interactions between charges on the surface of the bitumen-containing cuttings, and charges on the semi-hydrophobic monomer units.

Without being bound to any particular theory, additional properties of the drilling fluids of the present disclosure may be enhanced by anionic charges present on the ampholytic semi-hydrophobic polymers. For example, the presence of such anionic charges may reduce flocculation with other negatively charged components present in the drilling fluid (e.g. viscosofiers such as xanthan gum). The additional anionic functionalities may improve the solubility of the polymer in the aqueous solvent.

Described herein are embodiments of drilling fluids that can, among other functions, reduce bitumen accretion to wellbore drilling components and uses thereof. Also described herein are embodiments of methods for reducing bitumen accretion to wellbore drilling components. It will be appreciated by those skilled in the art that the drilling fluids, uses, methods, and embodiments described herein are for illustrative purposes intended for those skilled in the art and should not be construed as limiting in any way. Likewise, it will be appreciated by those skilled in the art that the volumes, masses, and other physical parameters described herein are for illustrative purposes intended for those skilled in the art and should not be construed as limiting in any way. All references to aspects, embodiments or examples throughout the disclosure should be considered references to illustrative and non-limiting aspects, embodiments or examples. All references to elements in the singular form should be considered to encompass plural forms of the same. All references to elements in the plural form should be considered to encompass singular forms of the same.

Aspects of the present disclosure relate to a drilling fluid comprising: an aqueous solvent; and an ampholytic semi-hydrophobic polymer that is readily hydratable under field mixing conditions, wherein the ampholytic semi-hydrophobic polymer comprises semi-hydrophobic monomer units comprising a C₁-C₇ hydrocarbyl substituent, a hydrogen substituent, or a combination thereof.

In the context of the present disclosure, the term “drilling fluid(s)” (also commonly referred to as “drilling mud(s)”) includes any of a number of liquids or mixtures of liquids with gases and solids (e.g. as solid suspensions, mixtures, emulsions, or combinations thereof) used in operations to drill wellbores into the earth.

In the context of the present disclosure, the term “aqueous solvent” includes any solvent which is water based. For example, the term “aqueous solvent” includes, but is not limited to, tap water, ground water, well water, salt water, brine, or combinations thereof.

In the context of the present disclosure, the term “ampholytic” refers to a species having both positive and negative formal charges.

In the context of the present disclosure, the term “semi-hydrophobic polymer” refers to a species that comprises semi-hydrophobic monomer units. The term “semi-hydrophobic polymer” is used to differentiate from the term “hydrophobic polymer” which, in the context of the present disclosure, refers to a species that comprises hydrophobic polymer units.

In the context of the present disclosure, the term “semi-hydrophobic monomer units” refers to a species that comprises cationic semi-hydrophobic monomer units, anionic semi-hydrophobic monomer units, non-ionic semi-hydrophobic monomer units, or combinations thereof. The term “semi-hydrophobic monomer units” is used to differentiate from the term “hydrophobic monomer units” which refers to a species that comprises cationic hydrophobic monomer units, anionic hydrophobic monomer units, non-ionic hydrophobic monomer units, or combinations thereof.

In the context of the present disclosure, the term “cationic semi-hydrophobic monomer units” refers to positively charged monomer units that comprise a C₁-C₇ hydrocarbyl substituent, a hydrogen substituent, or a combination thereof. The term “cationic semi-hydrophobic monomer units” is used to differentiate from the term “cationic hydrophobic monomer units” which refers to positively charged monomer units that comprise a C₈₊ hydrocarbyl substituent.

In the context of the present disclosure, the term “anionic semi-hydrophobic monomer units” refers to negatively charged monomer units that comprise a C₁-C₇ hydrocarbyl substituent, a hydrogen substituent, or a combination thereof. The term “anionic semi-hydrophobic monomer units” is used to differentiate from the term “anionic hydrophobic monomer units” which refers to negatively charged monomer units that comprises a C₈₊ hydrocarbyl substituent.

In the context of the present disclosure, the term “non-ionic semi-hydrophobic monomer units” refers to monomer units that are not formally charged and that comprise a C₁-C₇ hydrocarbyl substituent, a hydrogen substituent, or a combination thereof. The term “cationic semi-hydrophobic monomer units” is used to differentiate from the term “non-ionic hydrophobic monomer units” which refers to monomer units that are not formally charged and that comprise a C₈₊ hydrocarbyl substituent.

In the context of the present disclosure, the term “monomer unit(s)” refers to the largest constitutional unit contributed by a single monomer molecule to the structure of a polymer.

In the context of the present disclosure, the term “hydrocarbyl” refers to any univalent substituent derived from a hydrocarbon by substitution of a hydrogen atom from any carbon atom thereof. For example, the term “hydrocarbyl” includes alkyl, alkenyl, alkynyl, and aryl.

In the context of the present disclosure, the term “alkyl” refers to any univalent substituents derived from an alkane by substitution of a hydrogen atom from any carbon atom thereof. For example, the term “alkyl” includes, but may not be limited, to methyl, ethyl, n-propyl, cyclopropyl, n-butyl, sec-butyl, t-butyl, cyclobutyl, n-pentyl, cyclopentyl, n-hexyl, and cyclohexyl.

In the context of the present disclosure, the term “alkenyl” includes any univalent substituents derived from an alkene by substitution of a hydrogen atom from any carbon atom thereof. For example, the term “alkenyl” includes, but may not be limited, to ethenyl, propenyl, butenyl, pentenyl, cyclopentenyl, hexenyl, and cyclohexenyl.

In the context of the present disclosure, the term “alkynyl” includes any univalent substituents derived from an alkyne by substitution of a hydrogen atom from any carbon atom thereof. For example, the term “alkynyl” includes, but may not be limited, to ethynyl, propynyl, butynyl, pentynyl, and hexynyl.

In the context of the present disclosure, the term “aryl” includes any univalent substituent derived from an arene by substitution of a hydrogen atom from a ring carbon atom thereof. For example, the term “aryl” includes, but may not be limited to phenyl and methyl-substituted phenyl.

In the context of the present disclosure, the phrase “readily hydratable under field mixing conditions” is used to refer to polymers that uptake water when mixed with aqueous solvents using standard field mixing equipment under typical field mixing conditions within an acceptable time period.

Standard field mixing equipment includes, but is not limited to, paddle mixers having tanks sized between about 1 m³ and about 50 m³. As will be appreciated by those skilled in the art, paddle mixers provide only moderate sheer rate mixing. Typical field mixing conditions include but are not limited to: atmospheric pressure; ambient temperatures between about −35° C. and about 35° C.; and fluid temperatures between about −10° C. and about 100° C. Time periods for polymer hydration depend on numerous variables such as temperature, sheer rate, and polymer concentration. As will be appreciated by those skilled in the art, such time periods are considered “acceptable” when they do not result in delays outside of those typically encountered during polymer hydration in the field. As an example an ampholytic polymer is considered to be “readily hydratable under field mixing conditions” when it obtains greater than about 35% of the ultimate apparent viscosity thereof when mixed for about 10 minutes: in an approximately cylindrical container having a volume of 600 mL; at a speed of about 250 rpm with an approximately octagonal stir bar having a first dimension of about 0.7 cm and a second dimension of about 6 cm; at a concentration of about 5 kg/m³ in an aqueous solution having a volume of about 300 mL, a total dissolved solids measure of less than about 100 mg/L, and a pH of about 7; at a temperature within a range of about 20° C. to about 25° C.; and at a pressure of about 1 atm.

Field mixing conditions can vary considerably depending on, for example, the specific drilling rig setup. In general, field mixing may be completed by pre-hydrating the amphoteric semi-hydrophobic polymer in the aqueous solvent in a small volume paddle mixer (such as a paddle mixer having a volume between about 1 m³ and about 10 m³) to form a high concentration composition. For example, the amphoteric semi-hydrophobic polymer may be pre-hydrated at a concentration between about 1 kg/m³ and about 20 kg/m³. Aliquots of the high concentration composition may then be added into the active drilling fluid system as required. Field mixing may also be completed by direct addition of the amphoteric semi-hydrophobic polymer. For example, the amphoteric semi-hydrophobic polymer may be added into a surface tank of a wellbore drilling rig without pre-hydration. Drilling rig surface tanks are typically between about 10 m³ and about 50 m³ in volume, and they are typically mixed with paddle mixers.

Some embodiments of the present disclosure relate to drilling fluids wherein the semi-hydrophobic monomer units are present in the ampholytic hydrophobic polymer in an amount of less than about 10% (w/w). For example, between about 0.1% and about 7% (w/w), about 1% and about 5% (w/w), or about 2.5% and about 3.5% (w/w) of the ampholytic semi-hydrophobic polymer may be comprised of the semi-hydrophobic monomer units.

Some embodiments of the present disclosure relate to drilling fluids wherein the ampholytic semi-hydrophobic polymer obtains greater than about 35% of the ultimate apparent viscosity thereof when mixed for about 10 minutes: in an approximately cylindrical container having a volume of 600 mL; at a speed of about 250 rpm with an approximately octagonal stir bar having a first dimension of about 0.7 cm and a second dimension of about 6 cm; at a concentration of about 5 kg/m³ in an aqueous solution having a volume of about 300 mL, a total dissolved solids measure of less than about 100 mg/L, and a pH of about 7; at a temperature within a range of about 20° C. to about 25° C.; and at a pressure of about 1 atm.

Some embodiments of the present disclosure relate to drilling fluids wherein the C₁-C₇ hydrocarbyl substituent is a C₁-C₇ alkyl substituent, a C₂-C₇ alkenyl substituent, a C₂-C₇ alkynyl substituent, or a combination thereof. For example, the C₁-C₇ hydrocarbyl substituent may be a C₄-C₇ alkyl substituent, a C₄-C₇ alkenyl substituent, a C₄-C₇ alkynyl substituent, or a combination thereof. In particular, the C₁-C₇ hydrocarbyl substituent may comprise a C₆-alkyl substituent.

Some embodiments of the present disclosure relate to drilling fluids wherein the semi-hydrophobic monomer units are cationic semi-hydrophobic monomer units. For example, the semi-hydrophobic monomer units may comprise a quaternary ammonium substituent. In particular, the semi-hydrophobic monomer units may be cationic semi-hydrophobic monomer units as shown in formula (I) or formula (II):

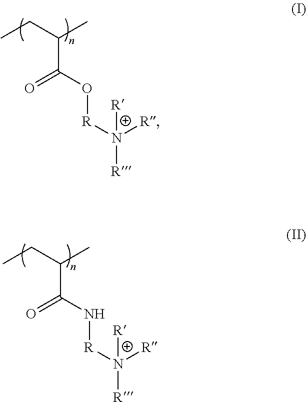

wherein:
(i) n is an integer between 1 and about 300,000, and R, R′, R″, and R″ are each independently a C₁-C₇ alkyl substituent, a C₂-C₇ alkenyl substituent, a C₂-C₇ alkynyl substituent, or a hydrogen substituent; or
(ii) n is an integer between 1 and about 300,000, and R, R′, R″, and R″ are each independently a C₄-C₇ alkyl substituent, a C₄-C₇ alkenyl substituent, or a C₄-C₇ alkynyl substituent.

In some embodiments of the present disclosure, only a portion of the cationic monomer units are cationic semi-hydrophobic monomer units. For example, between about 1% and about 99% (w/w) of the cationic monomer units may be cationic semi-hydrophobic monomer units.

Some embodiments of the present disclosure relate to drilling fluids wherein between about 0.1% and 10% (w/w) of the ampholytic semi-hydrophobic polymer is comprised of the cationic semi-hydrophobic monomer units. For example, between about 2% and about 4% (w/w) of the ampholytic semi-hydrophobic polymer may be comprised of the cationic semi-hydrophobic monomer units. In particular, about 3% (w/w) of the ampholytic semi-hydrophobic polymer may be comprised of the cationic semi-hydrophobic monomer units.

Some embodiments of the present disclosure relate to drilling fluids wherein the ampholytic semi-hydrophobic polymer further comprises anionic monomer units and non-ionic monomer units. For example, between about 0.1% and about 98% (w/w) of the ampholytic semi-hydrophobic polymer may be comprised of the anionic monomer units. In particular, between: about 0.5% and about 35% (w/w), about 1% and about 25% (w/w), or about 10% and about 15% (w/w) of the ampholytic semi-hydrophobic polymer may be comprised of the anionic monomer units. As a further example, between about 0.1% and about 98% (w/w) of the ampholytic semi-hydrophobic polymer may be comprised of the non-ionic monomer units. In particular, between: about 60% and about 97% (w/w), about 70% and about 95% (w/w), or about 80% and about 90% (w/w) of the ampholytic semi-hydrophobic polymer may be comprised of the non-ionic monomer units. The anionic monomer units may comprise monomer units having a carboxylate substituent or a sulfonate substituent. In particular, the anionic monomer units may comprise a carboxylate substituent (e.g. the anionic monomer units may be acrylate monomer units). Likewise, the non-ionic monomer units comprise monomer units having an amide substituent. In particular, the non-ionic monomer units may be acrylamide monomer units.

Some embodiments of the present disclosure relate to drilling fluids wherein the semi-hydrophobic monomer units are anionic semi-hydrophobic monomer units. In some embodiments, only a portion of the anionic monomer units are anionic semi-hydrophobic monomer units. For example, between about 1% and about 99% (w/w) of the anionic monomer units may be anionic semi-hydrophobic monomer units.

Some embodiments of the present disclosure relate to drilling fluids wherein the semi-hydrophobic monomer units are non-ionic semi-hydrophobic monomer units. In some embodiments, only a portion of the non-ionic monomer units are non-ionic semi-hydrophobic monomer units. For example, between about 1% and about 99% (w/w) of the non-ionic monomer units may be non-ionic semi-hydrophobic monomer units.

Some embodiments of the present disclosure relate to drilling fluids wherein the ampholytic semi-hydrophobic polymer has a molecular weight within a range of about 5,000 to about 30,000,000 Daltons. For example, the semi-hydrophobic polymer may have a molecular weight within a range of about 1,000,000 to about 10,000,000 Daltons, about 3,000,000 to about 6,500,000 Daltons, or about 4,500,000 to about 5,000,000 Daltons.

Some embodiments of the present disclosure relate to drilling fluids wherein the drilling fluid further comprises an additive.

In the context of the present disclosure, the term “additive” includes any material which is added to the drilling fluid in order to alter or enhance a physical property and/or a chemical property of the drilling fluid. Many additives are known in the art. Non limiting examples include: weighting compounds which increase the drilling fluid density for drilling through heavily pressurized zones (e.g., barite, hematite, magnetite, iron oxide, ilmenite, dolomite and/or calcite); corrosion inhibitors which preserve the life of metallic components (e.g. ammonium bisulfite and/or phosphate esters); viscosifiers, which, i.a., improve the ability of the drilling fluid to suspend and/or transport drill cuttings, including for example, bentonite, xanthan gum (e.g., Secure Vis™, XanVis® and OptiXan™), guar gum, diutan gum, sepiolite, attapulgite, sodium montmorillonite and/or various polymers and starches; lost circulation materials, which plug formation holes and fractures including, for example, granular materials (e.g., sized calcium carbonate, diatomaceous earth, perlite, vermiculite, and/or amine-treated lignite), flaky materials including, for example, mica, and/or pieces of plastic or cellophane, fibrous materials including, for example, shredded sugar cane, cotton fibers, wood fibers, corncobs, and/or shredded rubber; fluid-loss control materials, which reduce the amount of filtrate passing through a cake, including, for example, modified starch (e.g., Secure Star™), non-modified starch, polyanionic cellulose (e.g., Secure PAC LVD™ and RD™); lubricants including, for example, graphite, glass beads, diesel oil, synthetic oil, vegetable oil, animal oil and/or mineral oil; flocculants including, for example, hydrated lime, gypsum and/or synthetic polymers; thinners; deflocculants; dispersants; surfactants; biocides; pH control materials; scale inhibitors; shale stabilizers; iron controllers; defoamers, or combinations thereof.

In some embodiments, the additive may be a viscosifier (such as xanthan gum, diutan gum, sodium montmorillonite, or a combination thereof), a weighting compound, a corrosion inhibitor, a lost circulation material, a fluid-loss control material (such as polyanionic cellulose, a modified starch, a non-modified starch, or a combination thereof), a lubricant, a flocculant, a thinner, a deflocculant, a dispersant, a surfactant, a biocide, a pH control material, a scale inhibitor, a shale stabilizer, an iron controller, a defoamer, or a combination thereof.

Aspects of the present disclosure relate to use of the drilling fluid defined herein to reduce bitumen accretion to a wellbore drilling component.

In the context of the present disclosure, the term “bitumen” (also commonly referred to as asphalt, tar, or pitch) includes any hydrocarbon that is used to produce a petroleum product and that: is generally highly viscous, is in a semi-solid form under reservoir conditions, has a tendency to stick to drilling components, has a tendency to stick to metal components, or has a combination of the foregoing characteristics.

In the context of the present disclosure, the term “wellbore” (also commonly referred to as borehole) includes open-hole and/or cased portions of a drilled well. The term “wellbore” may refer to the inner diameter of a wall that defines a drilled hole.

In the context of the present disclosure, the term “drilling component(s)” includes, but is not limited to: a tubular within a wellbore (such as a casing, a drill string, a transition pipe, a heavyweight drill pipe, or a drill pipe), a drill bit, a bottom-hole assembly, an associated wellbore-component, a downhole tool and combinations thereof. The term “drilling component(s)” also includes components that process or circulate drilling fluids. For example, the term “drilling component(s)” includes, but is not limited, to shale shakers and components thereof (such as screens, suction lines, drilling fluid pumps, discharge lines, stand pipes, rotary hoses, and swivel and drive units).

Aspects of the present disclosure relate to a method for reducing bitumen accretion on a wellbore drilling component, the method comprising introducing a drilling fluid into a wellbore containing the wellbore drilling component, wherein the drilling fluid comprises: an aqueous solvent; and an ampholytic semi-hydrophobic polymer that is readily hydratable under field mixing conditions, wherein the ampholytic semi-hydrophobic polymer comprises semi-hydrophobic monomer units comprising a C₁-C₇ hydrocarbyl substituent, a hydrogen substituent, or a combination thereof.

Aspects of the present disclosure relate to a method for reducing bitumen accretion on a wellbore drilling component, the method comprising introducing the drilling fluid defined herein into a wellbore containing the wellbore drilling component.

Some embodiments of the present disclosure relate to methods for reducing bitumen accretion on a wellbore drilling component wherein the drilling fluid is circulated through the wellbore.

Some embodiments of the present disclosure relate to methods for reducing bitumen accretion on a wellbore drilling component further comprising separating drill cuttings from the drilling fluid.

In the context of the present disclosure, the term “drill cutting(s)” includes fragments of drilled material that are transported away from the drill bit through the wellbore to the surface by the drilling fluid.

### EXAMPLES

The following examples are presented to illustrate and demonstrate aspects of the disclosure and should not be construed as limited.

### Example 1

Laboratory testing was conducted to evaluate the extent to which two ampholytic polymers (A and B) are hydratable under field mixing conditions. Polymer A is an example of an ampholytic semi-hydrophobic polymer as defined herein. Polymer B is an example of an ampholytic hydrophobic polymer as is known in the art.

Polymer A had a molecular weight of between about 4,000,000 and about 5,000,000 Daltons. Polymer A included about 3% (w/w) of a cationic semi-hydrophobic monomer, between about 12 and about 15% (w/w) of an anionic monomer, and between about 82 and about 85% (w/w) of a non-ionic monomer. In polymer A, the cationic semi-hydrophobic monomer was as shown in formula (I) or formula (II):

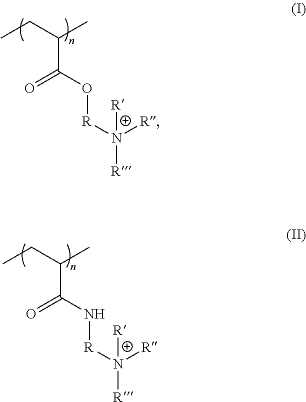

wherein:
n is an integer between 1 and about 300,000;
R, R′, R″, and R″ are each independently a C₁-C₇ alkyl substituent, a C₂-C₇ alkenyl substituent, a C₂-C₇ alkynyl substituent, or a hydrogen substituent; and
at least one of R, R′, R″, and R′″ is a C₆-alkyl substituent.

In polymer A, the anionic monomer was acrylate, and the non-ionic monomer was acrylamide.

Polymer B had a molecular weight of between about 4,000,000 and about 5,000,000 Daltons. Polymer B included about 1% (w/w) of a cationic hydrophobic monomer, between about 12% and about 15% (w/w) of an anionic monomer, and between about 84% and about 87% (w/w) of a non-ionic monomer. In polymer B, the cationic hydrophobic monomer was as shown in formula (I) wherein at least one of R, R′, R″, and R′″ was a C₈-hydrocarbyl, the anionic monomer was acrylate, and the non-ionic monomer was acrylamide.

The extent to which polymers A and B are hydratable under field mixing conditions was tested as follows.

Polymer A was suspended in deionized water in a first vessel at a concentration of 5 kg/m³. The volume of the deionized water was 300 mL, the pH of the deionized water was about 7, and the total dissolved solids measure of the deionized water was less than about 100 mg/L. The volume of the first vessel was 600 mL. The first vessel was generally cylindrical in shape.

At the same time, polymer B was suspended in deionized water in a second vessel that was equivalent to the first vessel at a concentration of 5 kg/m³. As with polymer A, the volume of the deionized water was 300 mL, the pH of the deionized water was about 7, and the total dissolved solids measure of the deionized water was less than about 100 mg/L.

A generally octagonal-shaped stir bar measuring about 0.7 cm by about 6 cm was added to each of the first vessel and the second vessel, and the suspensions were stirred at a speed of 250 rpm at approximately 22° C. After 10 minutes, the percent apparent viscosity of the contents of the first and second vessels was evaluated using an OFITE® Model 900 Viscometer. The viscosity measurement indicated that polymer A obtain about 57.4% of its ultimate viscosity. The viscosity measurement indicated that polymer B obtain about 31.6% of its ultimate viscosity. Accordingly, polymer A was found to be readily hydratable under field mixing conditions, and polymer B was not.

### Example 2

A series of laboratory tests was conducted to evaluate the fluid properties of a drilling fluid of the present disclosure as compared to a known drilling fluid. Table 1 summarizes the compositions of these fluids and their properties as subjected to shear rate testing using an OFITE® Model 900 Viscometer. Drilling fluid 1 included the ampholytic semi-hydrophobic polymer A set out in Example 1. Drilling fluid 2 included a cationic polymer known in the art (polymer C; Hyperdrill™ CP 905 H). Polymer C had a molecular weight of between about 5,000,000 and about 7,000,000 Daltons and included about 10% (w/w) of a cationic monomer, and about 90% (w/w) of a non-ionic monomer (acrylamide). Drilling fluids 1 and 2 were both water based and each contained a viscosifier (Secure Vis™).

TABLE 1

| | Drilling Fluid 1 | Drilling Fluid 2 |
|---|---|---|
| Water (g) | 300 | 300 |
| Secure Vis ™ (g) | 0.9 | 0.9 |
| A (g) | 1.5 | 0 |
| C (g) | 0 | 1.5 |
| Stir Rate (RPM) | | |
| 600 | 48.0 | 5.8 |
| 300 | 35.6 | 3.4 |
| 200 | 29.6 | 2.2 |
| 100 | 21.3 | 1.0 |
| 6 | 4.6 | 0.3 |
| 3 | 2.7 | 0.2 |
| Plastic Viscosity | 12.4 | 2.4 |
| (mPa · s) | | |
| Yield Point (Pa) | 11.6 | 0.5 |
| 10 second Gel (Pa) | 1.3 | 0.1 |
| 10 minute Gel (Pa) | 1.3 | 0.1 |

With Reference to Table 1, plastic viscosity represents drilling fluid viscosity as extrapolated to an infinite shear rate on the basis of the Bingham plastic model. A low plastic viscosity indicates that drilling can proceed at a fast rate because the drilling fluid exiting at the drill bit has low viscosity. The yield point is also a parameter of the Bingham plastic model (the zero-shear-rate intercept in a Bingham plastic fluid plot) and is used to evaluate the ability of a drilling fluid to transport drill cuttings. The 10 second and 10 minute gel properties are the shear stress measurements at a low shear rate after the drilling fluid has sat for 10 seconds or 10 minutes. It is an indication of the gel strength of a drilling fluid.

Testing results in Table 1 indicate that polymer A provides improved fluid properties relative to polymer C. For example, the yield point for drilling fluid 1 was more than 20 times greater than that of drilling fluid 2 (Table 1: row 14). Without being bound to any particular theory, it is suspected that the low viscosity observed for drilling fluid 2 is attributable to electrochemical interactions between the negatively charged xanthan gum and the positively charged anti-accretion polymer. Such interactions may have resulted in partial-precipitation of the resulting ion-pair.

### Example 3

A series of laboratory tests were conducted using a test procedure designed to evaluate the ability of drilling fluids to reduce bitumen accretion on a surface. The results are presented in Table 2. Sample 1 included the ampholytic semi-hydrophobic polymer A set out in Example 1. Sample 2 was used as a control, and did not include an anti-accretion agent. Samples 1 and 2 were otherwise identical. For example, equivalent amounts of water, Secure Vis™, Secure PAC R™, and Secure Star™ were used to prepare sample 1 and sample 2. The samples were tested with a 100-gram bitumen core and a metal test rod placed in an OFITE® rolling cell to simulate a drilling component. Two rolling cells were then rolled for 16 hours at room temperature, and the metal test rod and the internal wall of the rolling cell were inspected for bitumen accretion. The mass of the metal rod was also determined before and after any accreted bitumen was removed.

TABLE 2

| | Sample 1 | Sample 2 (control) |
|---|---|---|
| Water (g) | 300 | 300 |
| Secure Vis ™ (g) | 0.3 | 0.3 |
| Secure PAC R ™ | 1.2 | 1.2 |
| Secure Star ™ | 1.5 | 1.5 |
| A (mL) | 1.5 | 0 |
| Bitumen (g) | 100 | 100 |
| Mass of accreted bitumen | 0 | 27.1 |
| (g) | | |
| Observations | no bitumen on | bitumen sticking to |
| | metal test rod, | metal rod, wall of |
| | roller cell and lid | roller cell, and lid |
| | | severely |

Table 2 illustrates a reduction in bitumen accretion when the drilling fluid contained an ampholytic semi-hydrophobic polymer A of the present disclosure (sample 1), as compared to the case where the drilling fluid did not contain an anti-accretion agent (sample 2). It can, therefore, be concluded that drilling fluids that include the ampholytic semi-hydrophobic polymers described herein can reduce bitumen accretion to surfaces such as those of wellbore drilling components.

1. A drilling fluid comprising:
an aqueous solvent; and
an ampholytic semi-hydrophobic polymer that is hydratable under field mixing conditions,
wherein the ampholytic semi-hydrophobic polymer comprises a semi-hydrophobic monomer unit that comprises a C₁-C₇ hydrocarbyl substituent, a hydrogen substituent, or a combination thereof.

2. The drilling fluid of claim 1, wherein the semi-hydrophobic monomer units are present in the ampholytic hydrophobic polymer in an amount of less than about 10% (w/w).

3. The drilling fluid of claim 1, wherein the C₁-C₇ hydrocarbyl substituent is one of a C₄-C₇ alkyl substituent, a C₄-C₇ alkenyl substituent, a C₄-C₇ alkynyl substituent, and a combination thereof.

4. The drilling fluid of claim 1, wherein the semi-hydrophobic monomer unit comprises a cationic semi-hydrophobic monomer units.

5. The drilling fluid of claim 4, wherein the cationic semi-hydrophobic monomer unit comprises a quaternary ammonium substituent.

6. The drilling fluid of claim 4, wherein the cationic semi-hydrophobic monomer units are as shown in formula (I) or formula (II): 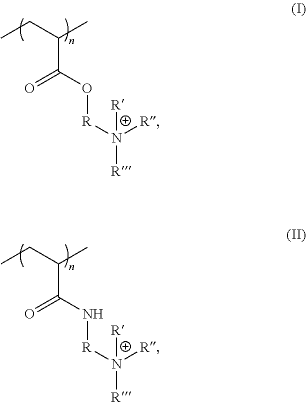
wherein n is an integer between 1 and about 300,000, and wherein R, R′, R″, and R″ are each independently a C₁-C₇ alkyl substituent, a C₂-C₇ alkenyl substituent, a C₂-C₇ alkynyl substituent, and a hydrogen substituent.

7. The drilling fluid of claim 6, wherein R, R′, R″, and R′″ are each independently a C₄-C₇ alkyl substituent, a C₄-C₇ alkenyl substituent, and a C₄-C₇ alkynyl substituent.

8. The drilling fluid of claim 1, wherein the ampholytic semi-hydrophobic polymer further comprises anionic monomer units and non-ionic monomer units.

9. The drilling fluid of claim 8, wherein the anionic monomer units are acrylate monomer units.

10. The drilling fluid of claim 8, wherein the non-ionic monomer units are acrylamide monomer units.

11. The drilling fluid of claim 1, wherein between about 2% and about 4% (w/w) of the ampholytic semi-hydrophobic polymer is comprised of a cationic semi-hydrophobic monomer unit.

12. The drilling fluid of claim 1, wherein between about 10% and about 20% (w/w) of the ampholytic semi-hydrophobic polymer is comprised of an anionic monomer unit.

13. The drilling fluid of claim 1, wherein between about 75% and about 95% (w/w) of the ampholytic semi-hydrophobic polymer is comprised of a non-ionic monomer unit.

14. The drilling fluid of claim 1, wherein the semi-hydrophobic monomer units are each an anionic semi-hydrophobic monomer unit.

15. The drilling fluid of claim 1, wherein the semi-hydrophobic monomer unit is a non-ionic semi-hydrophobic monomer unit.

16. A method for reducing bitumen accretion on a wellbore drilling component, the method comprising introducing a drilling fluid into a wellbore containing the wellbore drilling component, wherein the drilling fluid comprises:
an aqueous solvent; and
an ampholytic semi-hydrophobic polymer that is hydratable under field mixing conditions, wherein the ampholytic semi-hydrophobic polymer comprises semi-hydrophobic monomer units comprising a C₁-C₇ hydrocarbyl substituent, a hydrogen substituent, or a combination thereof.

17. A method for reducing bitumen accretion on a wellbore drilling component, the method comprising introducing the drilling fluid defined in claim 1 into a wellbore containing the wellbore drilling component.

18. The method of claim 16, wherein the drilling fluid is circulated through the wellbore.

19. The method of claim 17, wherein the drilling fluid is circulated through the wellbore.

20. The method of claim 18, further comprising separating drill cuttings from the drilling fluid.
